(19) United States
(12) Patent Application Publication
(10) Pub. No.: US 2006/0293957 A1
(43) Pub. Date: Dec. 28, 2006

(54) METHOD FOR PROVIDING ADVERTISING CONTENT TO AN INTERNET USER BASED ON THE USER'S DEMONSTRATED CONTENT PREFERENCES

(75) Inventors: Roger Petersen, Palo Alto, CA (US); Remigiusz K. Paczkowski, Belmont, CA (US)

Correspondence Address: CLARIA CORPORATION;c/o HAYNES BEFFEL & WOLFELD LLP, P.O. BOX 366, 751 KELLY STREET, HALF MOON BAY, CA, 94019, US

(73) Assignee: Claria Corporation, Redwood City, CA (US)

(21) Appl. No.: 11/427,282

(22) Filed: Jun. 28, 2006

Related U.S. Application Data
(60) Provisional application No. 60/694,533, filed on Jun. 28, 2005.

(51) Int. Cl. G06Q 30/00

(52) U.S. Cl. 705/14

(57) ABSTRACT

A method of tracking and publishing categorical user interest data, based on computer user behavior observed by a server coupled in communication with the user's computer. The method includes, as a first step, responsive to a user navigating with a browser to a first content site, receiving one or more categorical navigation history cookies. The next step constitutes categorizing the first content site into one or more subject categories (from a multiplicity of subject categories) and a sponsorship status (as hosting sponsored content or as navigation to sponsored content), which is followed by updating the categorical navigation history cookies to log by subject category and sponsorship status the user navigation to the first content site. The final step is sending to the user's browser the updated categorical navigation history cookies for persistent storage on the user's computer.

### RELATED APPLICATION

This application claims the benefit of U.S. Provisional Patent Application No. 60/694,533 entitled “Publishing Behavioral Observations to Customers” filed on Jun. 28, 2005. That application is incorporated by reference for all purposes.

### BACKGROUND OF THE INVENTION

The present invention relates generally to the field of market research, and in particular, it relates to the use of user behavior to define content offered to that user.

The technique of gathering information about consumer behavior on the internet was set out in commonly-owned U.S. patent application Ser. No. 11/226,066, entitled “Method and Device for Publishing Cross-Network User Behavioral Data” filed on 14 Sep. 2005. (the “'066” application). That application is incorporated by reference herein for all purposes.

The technique of the '066 application teaches how information about user behavior on the internet can be gathered. In sum, that application teaches that a behavior module can reside on a user computer, which module can observe and record user behavior in terms of keystrokes, mouse clicks and so on. Also, the behavior module can also observe information about websites visited by the user. In conjunction with software incorporated into the behavior module, data about the web site or web page can be analyzed and the site categorized into one of a set of categories defined by the behavior module. Information identifying the category, as well as information about the user's navigation behavior, such as the when the site was visited, how much time was spent there, and what the user did, can also be gathered by the behavior module. Finally, the behavior module can summarize the information and compact it into a form suitable for transmission, such the form generally known as a “cookie.”

What is not taught by the '066 application, and not seen in the art, is an understanding of how to employ such information to provide content to a user based on what that user wants to see. It remains to the present invention to provide such functionality to the art.

### SUMMARY OF THE INVENTION

An aspect of the invention is a method of tracking and publishing categorical user interest data, based on computer user behavior observed by a server coupled in communication with the user's computer. The method includes, as a first step, responsive to a user navigating with a browser to a first content site, receiving one or more categorical navigation history cookies. The next step constitutes categorizing the first content site into one or more subject categories (from a multiplicity of subject categories) and a sponsorship status (as hosting sponsored content or as navigation to sponsored content), which is followed by updating the categorical navigation history cookies to log by subject category and sponsorship status the user navigation to the first content site. The final step is sending to the user's browser the updated categorical navigation history cookies for persistent storage on the user's computer.

### BRIEF DESCRIPTION OF THE DRAWINGS

FIG. 1 illustrates a user computer connected to a network

FIG. 2 depicts a network comprising user computers, servers, and a behavior-responsive server, all in coupled communication.

FIGS. 3a and 3b illustrate an embodiment of a process for providing advertising content to a user based on prior user behavior.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

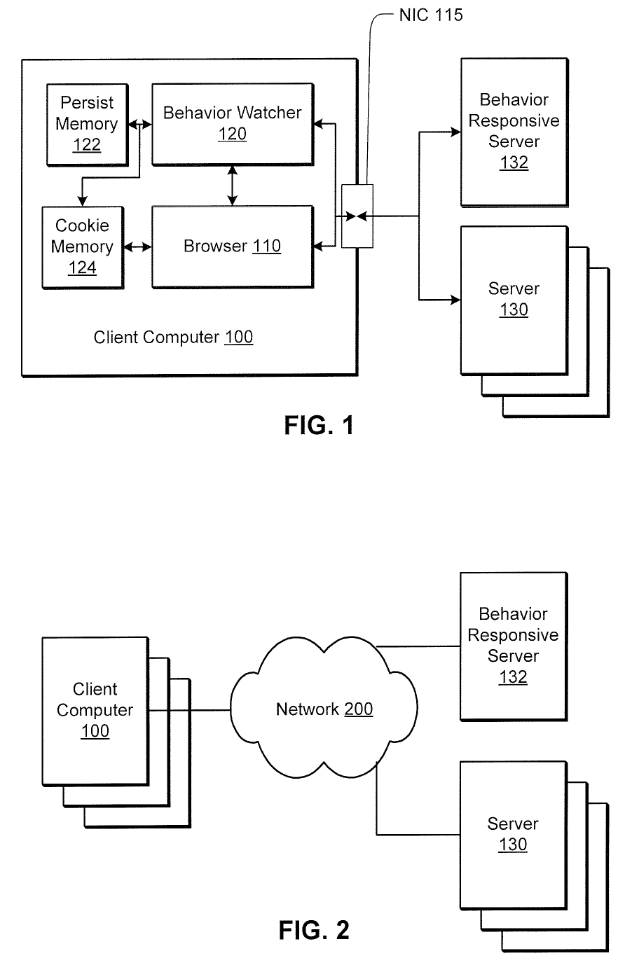

FIG. 1 is a schematic illustration of a client computer 100 interacting with a server 130 and a behavior responsive server 132. In FIG. 1, an end-user on a client computer indicates their interest in a subject by submitting a search request to a search engine, typing a URL or clicking on a link or banner ad. Their interest becomes a request across on a network such as the Intenet. A search engine may perform an Internet-wide search, or a search limited to a particular web site or domain name, or a search limited in some other way. The search request may be a query comprising one or more keywords, for example. The original search engine server 130 responds to the search request by sending a search result to the client computer 100. The search result may include a list of documents (e.g., web pages), links to documents, or other information relating to the keywords. A specific example of the just described scenario is an end-user typing the keyword “car” in a search engine and receiving back links to web sites that talk about car clubs, exotic cars, car racing, and like information.

A user submits a search request because of the user's interest in a topic. To make good use of the information about a user's interest, a behavior watching and/or behavior summarizing program 120 resident in the client computer listens for requests, for instance made using a browser 110 or other hyperlink enabled programs such as word processors or presentation programs. It listens for requests for information such as a search request, a click-through on a banner ad, or entry into the browser or click through of a destination URL. When the behavior watching program 120 detects that an end-user is performing a search or otherwise indicating their interest in a web site or subject, the behavior watching program records the interest. The interest may be recorded to program memory or to a persistent memory 122. When a user clicks on an advertisement related to the end-user's search request, the probability that the end-user will be interested in one or more related advertisements increases. In the car example, just above, the behavior watching program may note that the search was followed by certain click-throughs.

The behavior watcher 120 is resident in the client computer 100 so that it can respond to an end-user's search request even when the end-user uses different search engines. That is, unlike other targeting techniques that only work when an end-user is on a particular web site, the behavior watching program observes user interest across different search engines, web sites and even browsers. An end-user may obtain the behavior watching program by itself or along with free or reduced-cost computer programs, services, and other products.

The behavior responsive server 132 presents a new approach to providing content responsive to recent user behavior. User behavior has in the past been observed using a cookie with a unique user ID that allows server-side tracking. Server aggregated user behavior data is compiled among an organization of cooperating server owners. Cooperation may relate to ad serving (e.g., Double-Click), portals (e.g., Yahoo), search engines (e.g., Google) or other organizational basis. Cooperation in this sense is contractual more than technical. Server aggregated user behavior data is used, for instance, by an ad server when a web beacon (a small, null image with a URL pointing to an ad server) contacts the ad server and causes a unique user ID cookie to be transmitted. The ad server accesses a database, to update user behavior data with the new contact. The ad server could also access data from the server aggregated database, based on the unique user ID. A serious limitation of server aggregated user behavior data is that it is limited to contacts detected by cooperating servers when the user accesses cooperating web sites and the user's unique user ID cookie is transmitted. Mismatches of unique user IDs or multiple unique user IDs for the same user diminish the effectiveness of server-side aggregation. The combination of client-side user behavior tracking 120 and a reported-behavior responsive server 132 presents a new approach.

A reported-behavior responsive server 132 accepts one or more messages (e.g., cookies) that report recent user behavior as a basis for deciding among potential messages (e.g., banner ads) which message to give the user. The reported-behavior responsive server 132 need not access a server-side user behavior database to decide which message to send. Those of skill in the art will recognize that the new paradigm of reported behavior could be combined with server-side aggregation and that that combination also would be novel.

The ability of the cookies employed here to identify categories, as discussed below, departs from traditional uses of such cookies. The structures shown here can be termed “categorical” cookies to note this capability.

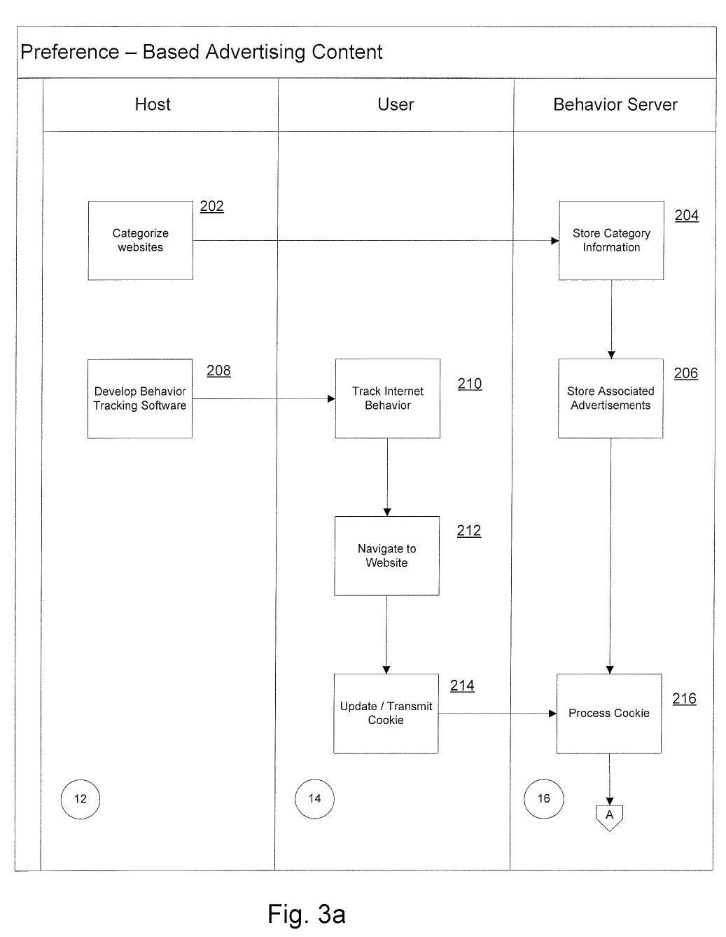

FIG. 2 is shown a schematic diagram of a computer network. Network 200 may include one or more client computers 100, one or more web server computers 130, one or more behavior responsive server computers 132, and other computers not shown. Intermediate nodes such as gateways, routers, bridges, Internet service provider networks, public-switched telephone networks, proxy servers, firewalls, and other network components are not shown for clarity. In the example of FIG. 2, network 200 includes the Internet; however, other types of computer networks may also be used. Computers may be coupled to network 200 using any type of connection 115 without detracting from the merits of the present invention.

A client computer 100 is typically, but not necessarily, a personal computer such as those running the Microsoft Windows™, Apple Macintosh™, Linux, or UNIX operating systems. An end-user may employ a suitably equipped client computer 100 to get on network 200 and access computers coupled thereto. For example, a client computer 100 may be used to access web pages from a web server computer 130. It is to be noted that as used in the present disclosure, the term “computer” includes any type of data processing device including personal digital assistants, digital telephones, wireless terminals, and the like.

A web server computer 130 may host a web site containing information designed to attract end-users surfing on the Internet. A web server computer 130 may host or cooperate with another server that hosts advertisements, downloadable computer programs, a search engine and products available for online purchase. A web server computer 130 may also host or cooperate with an ad server for that delivers advertisements to a client computer 100.

A reported-behavior responsive server computer 132 serves message units for delivery to a client computer 100. The message units may contain advertisements, for example. Message units are further described below. A reported-behavior responsive server computer 132 may also host downloadable computer programs and files for supporting, updating, or maintaining components on a client computer 100.

Web server computers 130 and reported-behavior responsive server computer 132 are typically, but not necessarily, server computers such as those available from Sun Microsystems, Hewlett-Packard, Dell or International Business Machines. A client computer 100 may communicate with a web server computer 130 or a reported-behavior responsive server computer 132 using client-server protocol. It is to be noted that client-server computing will not be further described here.

The components of a client computer 100 are not illustrated in a separate figure, but are well-understood. In one embodiment, the components of client computer 100 shown in FIG. 1 are implemented in software. It should be understood, however, that components in the present disclosure may be implemented in hardware, software, or a combination of hardware and software (e.g., firmware). Software components may be in the form of computer-readable program code stored in a computer-readable storage medium such as memory, mass storage device, or removable storage device. For example, a computer-readable medium may comprise computer-readable code for performing the function of a particular component. Likewise, computer memory may be configured to include one or more components, which may then be run by a microprocessor. Components may be implemented separately in multiple modules or together in a single module.

As shown in FIG. 1, client computer 100 may include a web browser 1110 and a behavior watching program 120. Web browser 110 may be a commercially available web browser or web client running on a client computer 100. In one embodiment, web browser 201 is the Microsoft Internet Explorer™ web browser. In another, it is a Mozilla, Netscape or Apple web browser. Alternatively, a web enabled word processor or presentation program may be monitored by the behavior watcher 120.

The behavior watching program 120 may be downloadable from a message server computer 103. Behavior watching program 120 may be downloaded in conjunction with the downloading of another computer program. For example, behavior watching program 120 may be downloaded to a client computer 100 along with a utility program that is provided free of charge or at a reduced cost. The utility program may be provided to an end-user in exchange for the right to deliver messages to the end-user via behavior watching program 120. In essence, revenue (e.g., advertising fees) from messages delivered to the end-user helps defray the cost of creating and maintaining the utility program. Other components such as operating system components, utility programs, application programs, and the like are not shown for clarity of illustration.

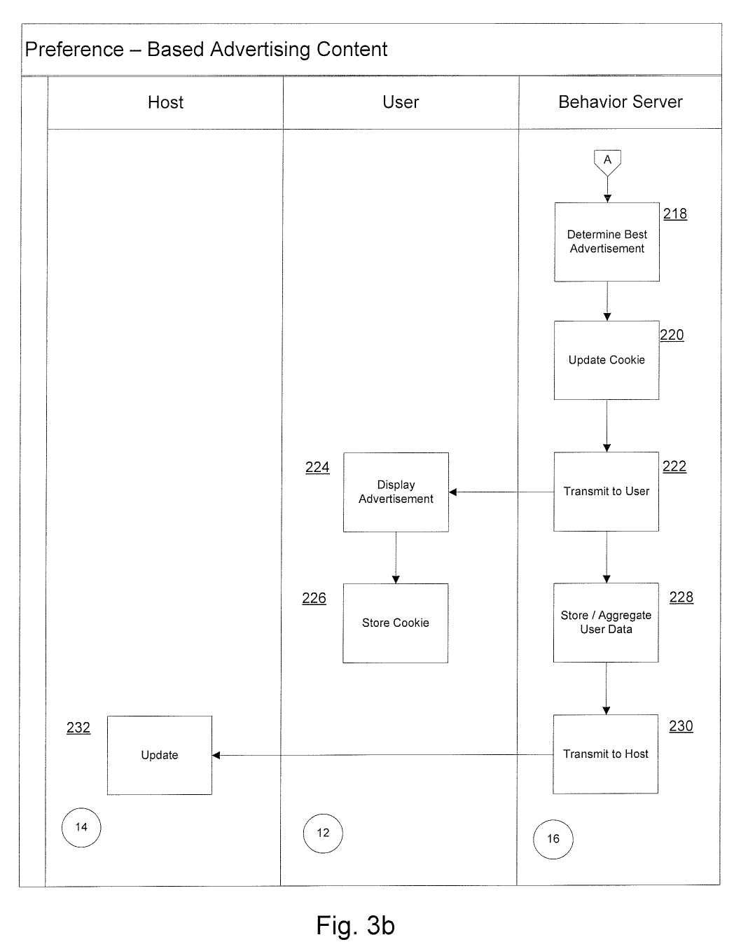

An embodiment of a process by which the present invention can provide preference-based advertising content to a user is illustrated in FIGS. 3a and 3b. As seen there, the process involves an interaction between three entities: a host company 12, a user 14 and a behavior-responsive server 16. The first entity develops and provides the software employed in the remainder of the process and cooperates in the process operation. The user can be any entity making use of the internet, most often an individual as described above. Similarly, the behavior-responsive server 16 corresponds to the behavior-responsive server 132 described above.

Initially, the host company conducts a survey of websites and assigns categories to as many commercially oriented websites as possible, step 202. This process is described in detail in commonly-owned U.S. Patent Application No. 11377,932 entitled “Method for Providing Content to an Internet User Based on the User's Demonstrated Content Preferences,” filed on Mar. 16, 2006. (the “'932” application). That application is incorporated herein for all purposes.

Results of that categorization, which can be in the form of a database containing both website identification information and associated categories, is provided to the behavior-responsive server in step 204. Similarly, the behavior-responsive server stores advertising content associated with categories, in step 206.

The user computer installs the software developed by the host (step 208) and begins tracking internet navigation behavior, step 210. As the user navigates to a website, step 212, a cookie is updated, step 214. The '066 application discusses such cookies in detail, and at this point it suffices to note that such cookies contain navigation information, including recency and usage data. As noted above, the relationship between these cookies and the categorization process allows these cookies to be termed “categorical” cookies, and that term will be employed henceforth. The user also transmits the categorical cookie to the behavior-responsive server.

The behavior-responsive server processes the received categorical cookie, step 216 which includes several distinct sub-steps. First, information about the current website location is unpacked. Then that site is categorized, employing the stored category information. Categorization of this sort is also set out in the '932 application.

Then, at step 218 (FIG. 3b), the behavior-responsive server determines the best advertisement fits the demonstrated interests of the user. That process is also set out in the '932 application, but here that process includes an analysis of the user history information contained in the categorical cookie, together with the categorization of the current site. That information is coupled with the advertising material available for display to determine the optimum advertising content to display to the particular user.

At step 220, the categorical cookie is updated to include the current site category information (recency and usage) as historical data. In this manner, two advantages are achieved. First, the storage load for retaining masses of user information is shifted to the user computers. Small amounts of such data will have no impact individually, but if the behavior-responsive server were required to do so, a significant burden would result. Second, response speed is materially improved, as the requirement to look up user history data is removed. In the environment set out here, the behavior-responsive server must respond on the fly, in real time, and streamlining a time-consuming database access assists that situation.

With the appropriate content selected and the categorical cookie updated, the behavior-responsive server can transmit results to the user for display, step 222. In the embodiment shown here, that step is accomplished by transmitting the categorical cookie and a link to the content. If desired, the content could be transmitted as well, though the bandwidth requirement for that task probably renders that solution impractical in many scenarios.

The user responds to this message by first displaying the content, step 224, which most likely involves retrieving content from a designated URL. Then, the categorical cookie is stored on the user computer, step 226. Cookie memory 124, seen in FIG. 1, is useful for that task.

The behavior-responsive server continues with follow-up actions after the transmission to the user. First, it stores, and possibly aggregates user data, step 228. It then transmits data to the host, step 230, enabling the host to undertake update actions, step 232.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A method of tracking and publishing categorical user interest data, based on computer user behavior observed by a server coupled in communication with the user's computer, the method including:
responsive to a user navigating with a browser to a first content site, receiving one or more categorical navigation history cookies;
categorizing the first content site into one or more subject categories (from a multiplicity of subject categories) and a sponsorship status (as hosting sponsored content or as navigation to sponsored content);
updating the categorical navigation history cookies to log by subject category and sponsorship status the user navigation to the first content site; and
sending to the user's browser the updated categorical navigation history cookies for persistent storage on the user's computer.

2. The method of claim 1, further including, responsive to at least one of the categorical navigation history cookies, selecting sponsored content of predicted interest to the user and sending the sponsored content to the user's browser for display.

3. The method of claim 2, wherein the sponsored content is linked for display to a display area provided by the first content site.

4. The method of claim 1, further including updating the categorical navigation history cookies to summarize observed user interest from the log of user navigations, the summary including at least a frequency or recency metric for observed interest in the subject categories.

5. The method of claim 1, further including updating the categorical navigation history cookies to summarize observed user interest from the log of user navigations, the summary including at least one metric of frequency and recency for observed interest in the subject categories.

6. The method of claim 1, further including, prior to sending the updated categorical navigation history cookies, deleting from the log of the user's navigation at least one old user navigation history entry.

7. The method of claim 1, wherein the received categorical navigation history cookies include a summary of observed user interest in the subject categories including at least a frequency or recency metric for observed interest, selecting sponsored content of predicted interest to the user and sending the sponsored content to the user's browser for display responsive to at least the summary.

8. A method of tracking and publishing categorical user interest data, based on computer user behavior observed by a server coupled in communication with the user's computer, the method including:
a user navigating with a browser to a first content site and transmitting one or more categorical navigation history cookies; and
the browser receiving one or more updated categorical navigation history cookies for persistent storage on the user's computer, wherein the updated cookies reflect categorization of the first content site into one or more subject categories (from a multiplicity of subject categories) and a sponsorship status (as hosting sponsored content or as navigation to sponsored content) and log by subject category and sponsorship status the user navigation to the first content site.

9. The method of claim 8, wherein the updated categorical navigation history cookies further summarize observed user interest from the log of user navigations, the summary including at least a frequency or recency metric for observed interest in the subject categories.

10. The method of claim 8, wherein the updated categorical navigation history cookies further summarize observed user interest from the log of user navigations, the summary including at least one metric of frequency and recency for observed interest in the subject categories.

11. The method of claim 8, further including the browser receiving, responsive to at least the categorical navigation history cookies, sponsored content.

12. The method of claim 11, wherein the user's browser displays the sponsored content in a display area specified within content provided by the first content site.

13. A computer-implemented method of automatically categorizing sponsored content based on observed user behavior, the method including:
receiving from a user who has navigated to a first content site one or more categorical navigation history cookies that include at least frequency or recency metrics for subject categories of content viewed by the user;
sending sponsored content to the user for display and recording at least part of the categorical navigation history cookies for the user, associating the recording with a sponsored content identifier;
repeating the receiving, sending and recording actions for a multiplicity of users who navigate to the first and additional content sites;
sometimes, receiving from the user a response to the sponsored content that requests further information and also receiving the categorical navigation history cookies;
recording at least part of the categorical navigation history cookies, associating the recording with the sponsored content identifier;
after reaching at least a threshold of user responses to the sponsored content, analyzing the recorded categorical navigation history cookies to determine navigation history characteristics useful to predict one or more subject categories in which the sponsored content evokes user response.

14. The method of claim 13, further including, responsive to receiving the categorical navigation history cookies from the user who navigated to the first content site, updating the navigation history cookies to log the user's navigation to the first content site, at least logging a subject category for the first content site.

15. The method of claim 14, wherein the updating of the categorical navigation history cookies is handled by a behavior monitoring module operating on a computer used by user.

16. The method of claim 14, wherein the updating of the categorical navigation history cookies is handled by a device through which communications are routed, between the user and the first and additional content sites, that is adapted to cause updated cookies to be persisted for the user.

17. The method of claim 14, wherein the updating of the categorical navigation history cookies is handled by a cookie updating server cooperating with the first and additional content sites and sending the updated cookies to the user.
